(19) United States
(12) Patent Application Publication
(10) Pub. No.: US 2020/0218659 A1
(43) Pub. Date: Jul. 9, 2020

(54) SYSTEMS AND METHODS FOR SECURE LOCKING OF A CACHE REGION

(71) Applicant: ALIBABA GROUP HOLDING LIMITED, George Town (KY)

(72) Inventor: Li ZHAO, San Mateo, CA (US)

(21) Appl. No.: 16/243,952

(22) Filed: Jan. 9, 2019

(51) Int. Cl. G06F 12/0855; G06F 12/0846

(52) U.S. Cl. CPC G06F 12/0855; G06F 2212/1052; G06F 2212/1008; G06F 12/0848

(57) ABSTRACT

The present disclosure relates to computer-implemented systems and methods for locking a region in a cache. In one implementation, a system for locking a cache region may include least one cache configured to store data; at least one register configured to store addresses; and at least one logic circuit configured to perform operations. The operations may include select a portion of the at least one cache for storing one or more lines of data; apply one or more comparator functions to one or more addresses of the selected portion and the stored addresses; and when the one or more addresses of the selected portion and the stored addresses do not overlap, store the one or more lines of data in the selected portion.

### TECHNICAL FIELD

The present disclosure relates generally to the field of cache operations. More specifically, and without limitation, this disclosure relates to computer-implemented systems and methods for securely locking cache regions. The systems and methods disclosed herein may be used in various cache-based hardware architectures, such as central processing units (CPUs), digital signal processors (DSPs), memory management units (MMUs), or the like; cache-based software architectures, such as a page cache, a web cache, or the like; or any other architectures that use caches.

### BACKGROUND

To increase the speed of retrievals from storages with higher latencies (such as random access memories (RAMs), hard disks, or the like), processors often use one or more levels of cache, whether on-chip or off-chip, to increase efficiency for fetching instructions and other data. Software applications may use caches for similar reasons, e.g., caches to store data from the Internet or another network to avoid high-latency retrieves from the Internet or other network, caches to store files from higher-latency memories (such as a hard disk, a flash memory, or the like) in lower-latency memories (such as RAM), or the like. However, these caches, particularly caches for processors, result in a security vulnerability. For example, a malicious instruction set may deliberately access or even modify cache information used by other applications.

### SUMMARY

In some embodiments, a system for locking a cache region may comprise at least one cache configured to store data; at least one register configured to store addresses; and at least one logic circuit configured to perform operations. The operations may comprise select a portion of the at least one cache for storing one or more lines of data; apply one or more comparator functions to one or more addresses of the selected portion and the stored addresses; and when the one or more addresses of the selected portion and the stored addresses do not overlap, store the one or more lines of data in the selected portion.

In some embodiments, a method for locking a cache region may comprise selecting a portion of at least one cache for storing one or more lines of data; applying one or more comparator functions to one or more addresses of the selected portion and stored addresses in at least one register; and when the one or more addresses of the selected portion and the stored addresses do not overlap, storing the one or more lines of data in the selected portion.

In some embodiments, a non-transitory computer-readable storage medium may store a set of instructions that is executable by at least one logic circuit of a processor to cause the logic circuit to perform a method for locking a cache region. The method may comprise selecting a portion of at least one cache for storing one or more lines of data; applying one or more comparator functions to one or more addresses of the selected portion and stored addresses in at least one register; and when the one or more addresses of the selected portion and the stored addresses do not overlap, storing the one or more lines of data in the selected portion.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 is a schematic representation of a single-core processor, according to embodiments of the present disclosure.

FIG. 2A is an exemplary register for storing properties of a secured cache region, according to embodiments of the present disclosure.

FIG. 2B is an exemplary register for storing an address of a secured cache region, according to embodiments of the present disclosure.

FIG. 3 is a schematic representation of a cache using lock bits, according to embodiments of the present disclosure.

FIG. 4 is a schematic representation of comparators for finding secure cache regions, according to embodiments of the present disclosure.

FIG. 5A is a flowchart of an exemplary method for locking a cache region, according to embodiments of the present disclosure.

FIG. 5B is a flowchart of an exemplary method for clearing a locked cache region, according to embodiments of the present disclosure.

FIG. 6A is a flowchart of an exemplary method for locking a cache region, according to embodiments of the present disclosure.

FIG. 6B is a flowchart of an exemplary method for clearing a locked cache region, according to embodiments of the present disclosure.

FIG. 7 is a depiction of an exemplary computer system for executing methods consistent with the present disclosure.

### DETAILED DESCRIPTION

The disclosed embodiments relate to computer-implemented systems and methods for locking cache regions and clearing the same. Advantageously, the exemplary embodiments can provide improved security over conventional caches. Embodiments of the present disclosure may be implemented and used in any cache-based architectures. Accordingly, although described in reference to central processing units (CPUs), other cache-based hardware architectures, such as hardware digital signal processors (DSPs), memory management units (MMUs), or the like, may use the techniques disclosed herein to lock and release cache regions. In addition, cache-based software architectures, such as a page cache, a web cache, or the like, may similarly use the techniques disclosed herein to lock and release cache regions.

In view of the foregoing issues with conventional systems, embodiments of the present disclosure provide computer-implemented systems and methods for securely locking cache regions associated with one or more processors. The systems and methods of the present disclosure may provide a technical solution to the technical problem of solving the security vulnerabilities created by the use of cache. The systems and methods of the present disclosure may result in more secure cache architectures.

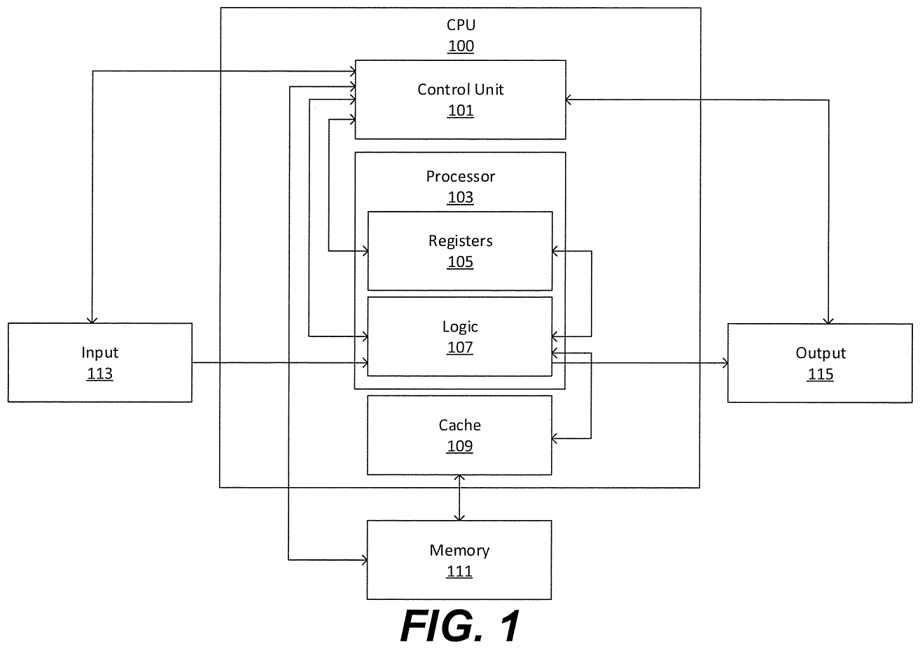

FIG. 1 is a schematic representation of an exemplary central processing unit (CPU) 100 (or other processor such as a graphical processing unit (GPU) or the like). As depicted in FIG. 1, CPU 100 may include a control unit 101 that communicates with other portions of CPU 100. Control unit 101 may comprise a plurality of transistors (or other electrical components such as capacitors, resistors, arbiters, or the like) that provide timing and control signals to other components of CPU 100 as well as controlling timing of input 113 (e.g., from a peripheral such as a keyboard, a mouse, or the like or from another portion of a machine in which CPU 100 is used) and output 115 (e.g., to a display controller or other output device or to another portion of a machine in which CPU 100 is used).

As further depicted in FIG. 1, CPU 100 may include a processor 103. For example, processor 103 may comprise a processor core of CPU 100. As depicted in FIG. 1, processor 103 includes one or more registers 105 and one or more logic circuits 107. For example, a register may comprise a small (e.g., 8-bit, 16-bit, 32-bit, 64-bit, 128-bit, or the like) amount of storage (e.g., a small static random access memory (SRAM) or the like). Additionally or alternatively, a register may comprise a hardware accelerator (e.g., for performing accumulate and other particular functions). Logic circuits 107 may comprise an arithmetic logic unit (ALU) or any other collection of transistors (or other electrical components such as capacitors, resistors, arbiters, or the like) that perform functions on data accessible by processor 103. For example, as shown in FIG. 1, logic circuits 107 may operate on input 113, any data stored in registers 105, any data stored in cache 109, or the like.

Cache 109 may comprise one or more levels of cache storage (e.g., SRAM, dynamic random access memory (DRAM), or the like) that retrieve and temporarily store data and instructions from main memory 111 and used by logic circuits 107. Although depicted as off-chip storage in FIG. 1, cache 109 may additionally or alternatively include on-chip storage. Main memory 111 may comprise off-chip memory with higher latency than cache 109, such as one or more sticks of DRAM or the like. Additionally or alternatively, main memory 111 may reside on another machine and be accessed by CPU 100 via, for example, a computer network (e.g., the Internet, a local area network (LAN), or the like).

Although depicted separately in FIG. 1, the components of CPU 100 may be integrated into a single integrated circuit (IC), such as a system-on-a-chip (SoC) architecture. Moreover, while CPU 100 is a single-core processor, it is appreciated that the methods and systems discussed below also apply to processors with more than one core. Similarly, while CPU 100 is a scalar processor, it is appreciated that the methods and systems discussed below also apply to superscalar processors.

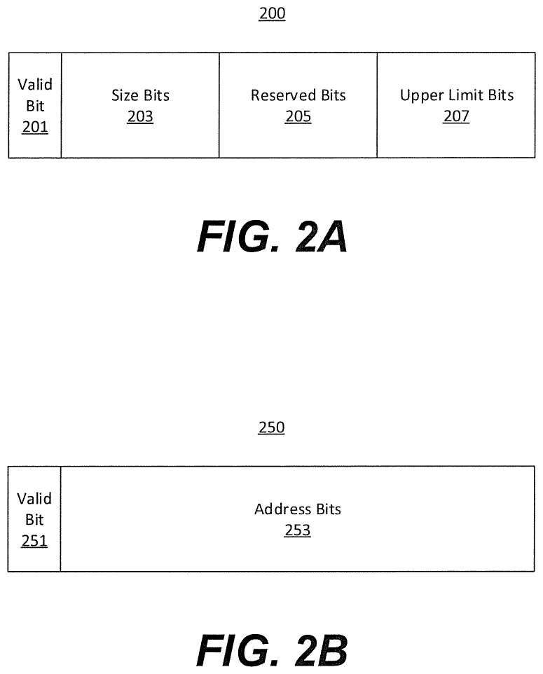

FIG. 2A is a representation of a schema 200 for storing properties of a secure cache region in a register (e.g., one of registers 105 of CPU 100 of FIG. 1), consistent with embodiments of the present disclosure. As depicted in FIG. 2A, at least one bit 201 may store a value indicating whether a region in an associated cache (e.g., cache 109 of CPU 100 of FIG. 1) is a valid region to be locked. As further depicted in FIG. 2A, bits 203 may define a size of a secured region in the cache. In addition, bits 207 may define a maximum size of a region in the cache. The maximum size may be dependent on a basic input/output system (BIOS) setting, and thus bits 207 may be read-only. Bits between those defining the size of the region and the maximum size (e.g., bits 205) may be reserved. For example, this may allow the size of the region to be increased without overwriting the read-only bits 207 defining a maximum allowable size.

FIG. 2B is a representation of a schema 250 for storing an address of a secure cache region in a register (e.g., one of registers 105 of CPU 100 of FIG. 1), consistent with embodiments of the present disclosure. As depicted in FIG. 2B, at least one bit 251 may store a value indicating whether a region in an associated cache (e.g., cache 109 of CPU 100 of FIG. 1) is a valid region to be locked. As further depicted in FIG. 2B, bits 253 may define a starting address of a secured region in the cache. Schema 250 may be combined with schema 200 such that secure regions are defined by two registers: one storing a starting address and another storing a size of the secure region.

It is appreciated that other encoding schemes may be used and that schema 200 and 250 are exemplary only. For example, schema 200 may define an address at which the secure region terminates in addition to or in lieu of size bits 205. Alternatively, schema 250 may use pairs of registers to define starting and ending addresses rather than a single register with a starting address. In any embodiments, valid bit 201 may be eliminated or valid bit 251 may be eliminated from schema 200 or schema 250, respectively. It is appreciated that schema 200 and 250 are subject to the size of registers included in the processor. For example, if registers are 64-bits within a 64-bit operating environment, valid bit 251 may be eliminated such that schema 251 may store a starting address within a single register. In another example, if registers are 128-bits within a 64-bit operating environment, schema 250 may store a starting and ending address in the same register rather than a pair of registers. In a software implementation of the embodiments disclosed herein, such size limitations are not existent unless there is a need to limit definitions of the secured regions to a particular number of blocks in a memory.

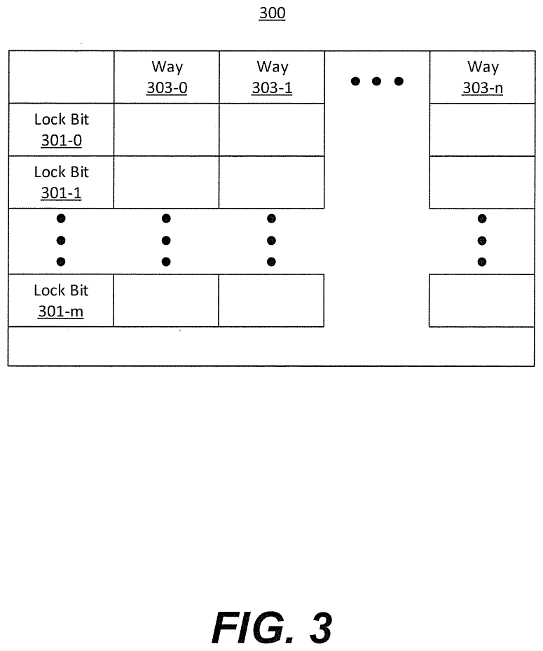

FIG. 3 depicts exemplary cache 300 using lock bits, consistent with embodiments of the present disclosure. It is appreciated that cache 300 is a multi-way associated cache. However, embodiments of the present disclosure may be used in a direct-mapped cache or any other cache in a similar manner to that depicted in FIG. 3. In the example of FIG. 3, cache 300 includes m+1 sets (depicted logically as rows) and n+1 ways (depicted logically as columns way 303-0, way 303-1, . . . , way 303-n). Length m and length n may be the same or different, depending on the relationship between cache size and associative relationships of the cache.

As depicted in FIG. 3, one bit of each set in cache 300 is reserved as a lock bit, e.g., lock bits 301-0, 301-1, . . . , 301-m. In such embodiments, each lock bit may indicate whether an associated set includes protected data that cannot be deleted or accessed without appropriate permissions. Although depicted as using a lock bit for each set, cache 300 may additionally or alternatively use a lock bit associated with each way.

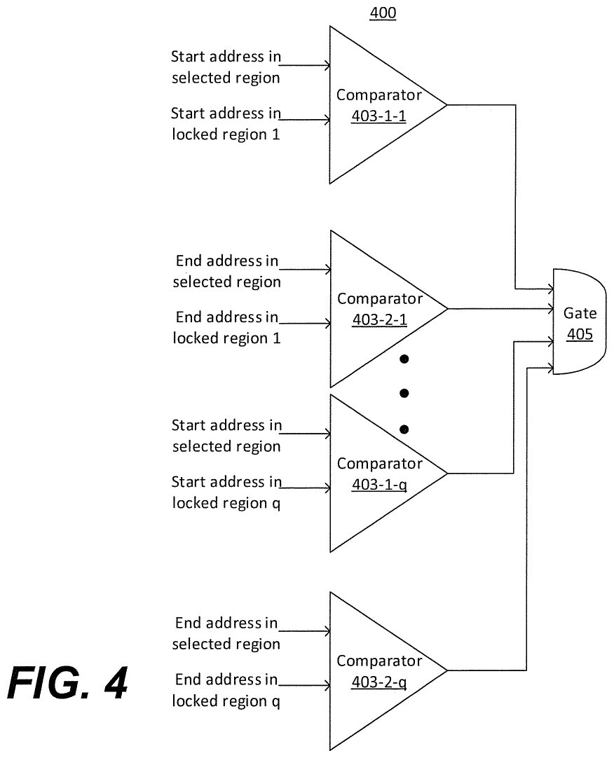

In some embodiments, in lieu of the lock bits depicted in FIG. 3, embodiments of the present disclosure may use schema 200 of FIG. 2A, schema 250 of FIG. 2B, or the like to determine which regions of the cache are locked (or secured). For example, some embodiments may use comparator system 400 of FIG. 4 to determine whether a cache region is locked (or secured) in lieu of (or in addition to) the lock bits depicted in FIG. 3. The lock bits of FIG. 3 may provide a faster mechanism for checking whether a region is locked but provide less flexibility with respect to defining locked regions and rendering less cache space usable for data (due to the lock bits).

As depicted in FIG. 4, system 400 may include two comparators (e.g., comparator 403-1-1 and comparator 403-2-1 or comparator 403-1-q and comparator 403-2-q) for each locked region in the cache. Accordingly, by using the comparators to compare start and end addresses of selected regions with locked regions, system 400 may determine whether the selection region overlaps with a locked region. Although in the example of FIG. 4, q locked regions are used, any number of locked regions may be used in the cache. The results from the comparators may be aggregated, e.g., using gate 405, to determine whether the selected region overlaps with any locked regions in the cache. If so, a new region may be selected for use; if not, the selected region may be used for writing.

Although not depicted in FIG. 4, in an alternative embodiment, one comparator may correspond to each way (e.g., ways 303-0, 303-1, . . . , 303-n as depicted in FIG. 3). In such an embodiment, the comparators may determine, in parallel, which ways are locked such that a non-locked way may be selected for writing. Although requiring more comparators, such an embodiment may be faster than the embodiment depicted in FIG. 4.

Although not depicted in FIG. 4, in some embodiments, the start or end addresses may comprise extrapolated addresses. For example, system 400 may use a starting address of a secured region stored in at least one register in combination with a size of the secured region stored in the same register(s) or one or more different registers to extrapolate remaining addresses of the secured region. As another example, system 400 may use a starting address of a secured region stored in at least one register in combination with an ending address of the secured region stored in the same register(s) or one or more different registers to extrapolate remaining addresses of the secured region.

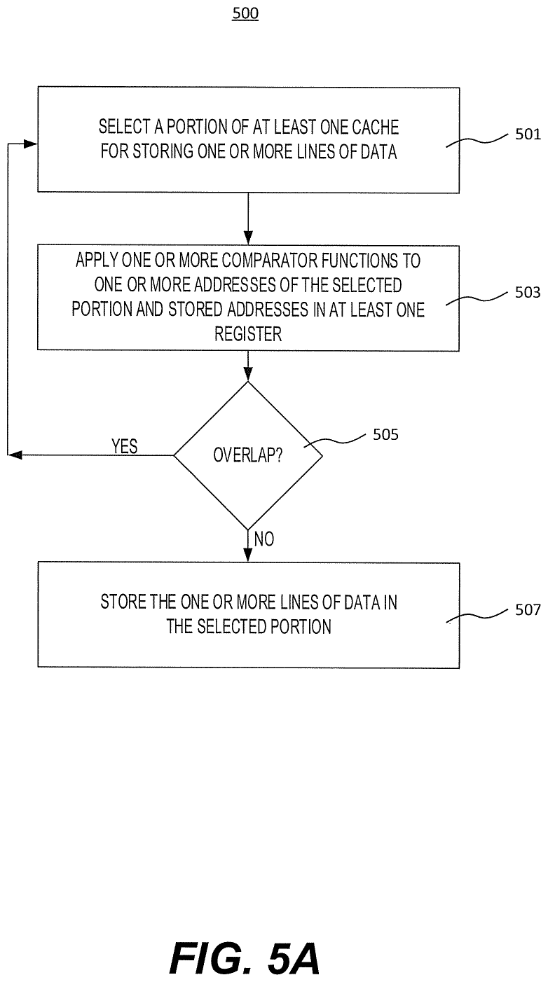

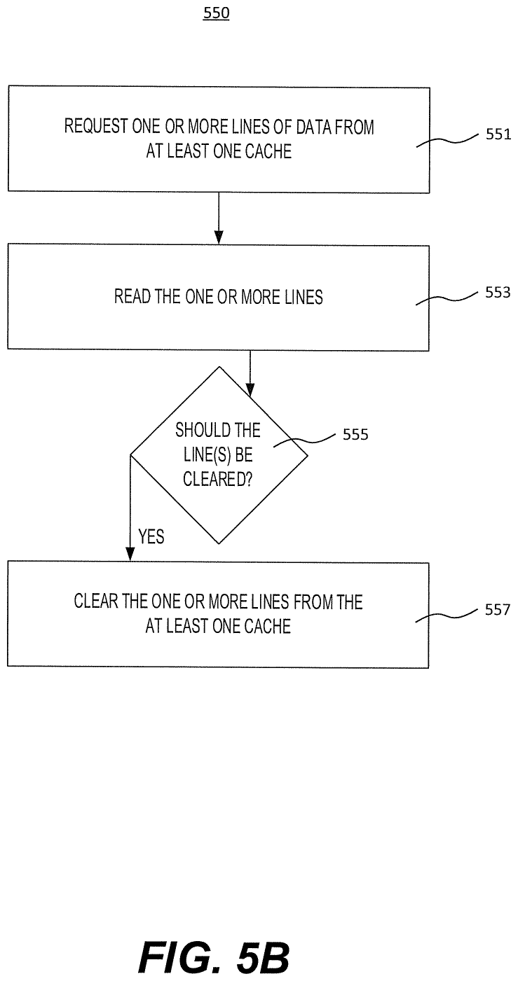

FIG. 5A is a flowchart of an exemplary method 500 for locking a cache region. Method 500 may be performed by at least one logic circuit (e.g., part of logic circuits 107 of processor 103 of FIG. 1). Although described using a CPU, method 500 may apply to any processor architecture using one or more caches or any software architecture using one or more caches.

In some embodiments, the at least one cache, the at least one register, and the at least one logic circuit of method 500 may comprise components of a processor. For example, the processor may comprise a central processing unit (CPU), e.g., as depicted in FIG. 1. In other embodiments, the at least one cache, the at least one register, and the at least one logic circuit of method 500 may comprise components of different processors, e.g., in a multi-processor system including a plurality of CPUs, GPUs, or the like.

At step 501, the at least one logic circuit may select a portion of at least one cache for storing one or more lines of data. In some embodiments, the selection may be at least pseudo-random. For example, a pseudo-random algorithm may select the portion. In embodiments where the processor has a Geiger counter, an avalanche diode, or any other hardware random number generator (HRNG), the pseudo-random selection may be made a true random selection.

In other embodiments, the selection may be based, at least in part, on the stored addresses. For example, the at least one logic circuit may select a region with a starting address or at least including an address higher than the last-locked address. In another example, the at least one logic circuit may select a region currently marked as unlocked, e.g., by assessing lock bits (e.g., as depicted in FIG. 3), by assessing stored addresses of locked regions (e.g., as depicted in FIGS. 2A and 2B), or the like.

At step 503, the at least one logic circuit may apply one or more comparator functions to one or more addresses of the selected portion and the stored addresses. For example, the at least one logic circuit may apply comparators as depicted in FIG. 4 (e.g., using general logic circuits configured according to software or hardware accelerators configured to function as comparators). As described with respect to FIG. 4, the at least one logic circuit may perform extrapolation before applying the one or more comparator functions.

At step 505, the at least one logic circuit may determine whether the one or more addresses of the selected portion and the stored addresses overlap. When there is an overlap, the at least one logic circuit may return to step 501 and select a new portion of the at least one cache. For example, the at least one logic circuit may select a new portion of the at least one cache for storing the one or more lines of data; apply the one or more comparator functions to one or more addresses of the selected new portion and the stored addresses; and when the one or more addresses of the selected new portion and the stored addresses do not overlap: store the one or more lines of data in the selected new portion.

In some embodiments, the selection of the new portion may be at least pseudo-random, as described above. In other embodiments, the selection of the new portion may be based, at least in part, on results from applying the one or more comparator functions to the one or more addresses of the selected portion and the stored addresses. For example, the results of step 503 may be used to adjust any overlaps between the portion from step 501 and the stored addresses to construct the new portion.

When there is no overlap, at step 507, the at least one logic circuit may store the one or more lines of data in the selected portion. Accordingly, any data already stored in the selected portion may be overwritten or written back to a main memory (e.g., main memory 111 of FIG. 1).

Consistent with the present disclosure, the example method 500 may include additional steps. For example, in some embodiments, method 500 may further include reading and clearing the stored one or more lines as depicted in FIG. 5B.

In some embodiments, the stored addresses of the at least one register may be predetermined by an operating system, a program included in a BIOS, or otherwise controlled by a hardware-level software application. Additionally or alternatively, the stored addresses of the at least one register may be dynamically allocated. For example, one or more applications may request (e.g., using an operating system, a program included in a BIOS, or any other hardware-level software application) one or more locked cache regions for instructions or data. Accordingly, after the application is terminated or otherwise no longer needs a secured region, the operating system, program included in the BIOS, or the other hardware-level software application may unlock the region(s) by removing address(es) of the region(s) from the at least one register.

FIG. 5B is a flowchart of an exemplary method 550 for reading and clearing a cache region. Method 550 may be performed by at least one logic circuit (e.g., part of logic circuits 107 of processor 103 of FIG. 1). Although described using a CPU, method 550 may apply to any processor architecture using one or more caches or any software architecture using one or more caches.

In some embodiments, the at least one cache, the at least one register, and the at least one logic circuit of method 550 may comprise components of a processor. For example, the processor may comprise a central processing unit (CPU), e.g., as depicted in FIG. 1. In other embodiments, the at least one cache, the at least one register, and the at least one logic circuit of method 550 may comprise components of different processors, e.g., in a multi-processor system including a plurality of CPUs, GPUs, or the like.

At step 551, the at least one logic circuit may request one or more lines of data from at least one cache. For example, the at least one logic circuit may request instructions or other data as required by a current instruction set that the at least one logic circuit or another logic circuit is executing.

At step 553, the at least one logic circuit may read the one or more lines from the at least one cache. For example, the at least one logic circuit may transfer the lines to itself or another logic circuit for execution (if the lines are instructions) or for operation on (if the lines are data such as integers, floating decimals, strings, Booleans, or the like).

At step 555, the at least one logic circuit may determine whether the one or more lines should be cleared. For example, the at least one logic circuit may check whether the one or more lines are within a region having one more addresses in at least one register storing locked addresses. If so, the lines are not cleared. If not, the lines may be cleared.

In some embodiments, the at least one logic circuit may clear the one or more lines directly, e.g., by setting all bits storing the one or more lines to zeroes. In other embodiments, to increase efficiency of the at least one cache, the at least one logic circuit may mark the one or more lines as unlocked without clearing the one or more lines. Accordingly, the one or more lines will be cleared with continued use of the cache.

As explained above, the locked addresses stored in the at least one register may be predetermined by an operating system, a program included in a BIOS, or otherwise controlled by a hardware-level software application or may be dynamically allocated. For example, one or more applications may request (e.g., using an operating system, a program included in a BIOS, or any other hardware-level software application) one or more locked cache regions for instructions or data. Later, the operating system, program included in the BIOS, or the other hardware-level software application may unlock the region(s) by removing address(es) of the region(s) from the at least one register once no longer needed. For example, if the application will require the same instructions or data again, the region(s) may be preserved. On the other hand, if the instructions or data will not be used within a threshold period of time (e.g., within a certain number of processing cycles) or the application is terminated, the region(s) may be unlocked.

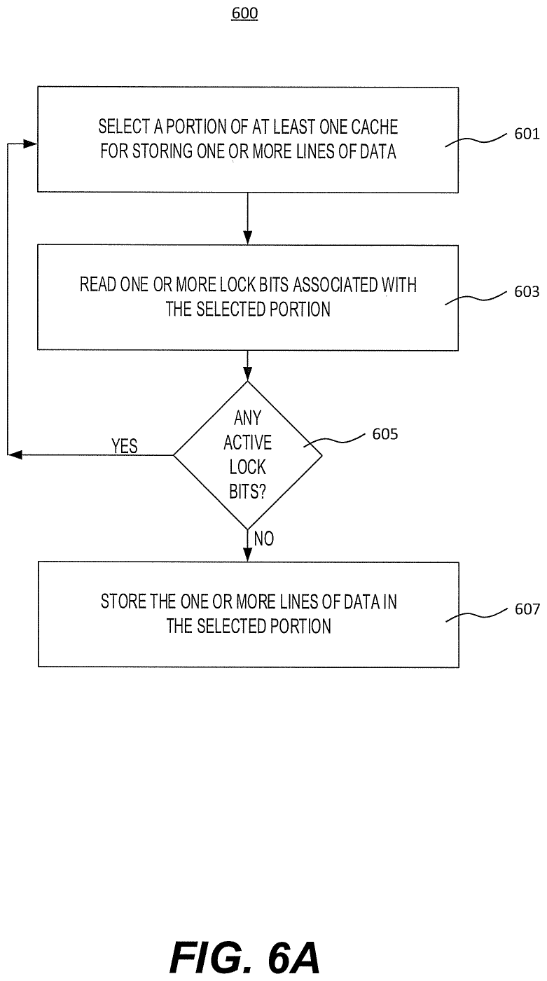

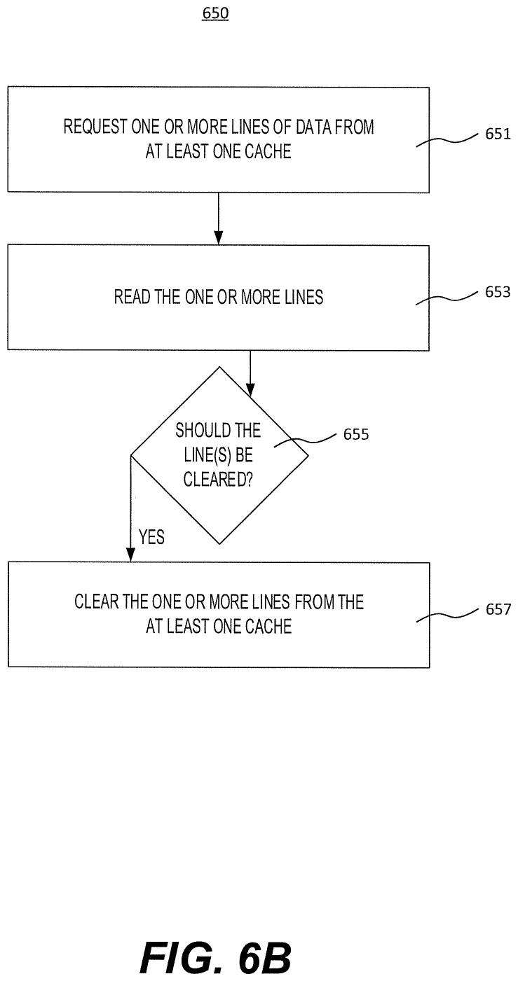

FIG. 6A is a flowchart of an exemplary method 600 for locking a cache region. Method 600 may be performed by at least one logic circuit (e.g., part of logic circuits 107 of processor 103 of FIG. 1). Although described using a CPU, method 600 may apply to any processor architecture using one or more caches or any software architecture using one or more caches.

Method 600 may be faster than method 500 because lock bits are used rather than comparators. However, method 600 may require a larger cache for the lock bits. Moreover, method 600 may provide less flexibility than method 500 because a whole set or a whole way is locked by a lock bit rather than a region defined by one or more addresses in one or more registers.

In some embodiments, the at least one cache, the at least one register, and the at least one logic circuit of method 600 may comprise components of a processor. For example, the processor may comprise a central processing unit (CPU), e.g., as depicted in FIG. 1. In other embodiments, the at least one cache, the at least one register, and the at least one logic circuit of method 600 may comprise components of different processors, e.g., in a multi-processor system including a plurality of CPUs, GPUs, or the like.

At step 601, the at least one logic circuit may select a portion of at least one cache for storing one or more lines of data. In some embodiments, the selection may be at least pseudo-random. For example, a pseudo-random algorithm may select the portion. In embodiments where the processor has a Geiger counter, an avalanche diode, or any other hardware random number generator (HRNG), the pseudo-random selection may be made a true random selection.

In other embodiments, the selection may be based, at least in part, on the stored addresses. For example, the at least one logic circuit may select a region with a starting address or at least including an address higher than the last-locked address. In another example, the at least one logic circuit may select a region currently marked as unlocked, e.g., by assessing lock bits (e.g., as depicted in FIG. 3), by assessing stored addresses of locked regions (e.g., as depicted in FIGS. 2A and 2B), or the like.

At step 603, the at least one logic circuit may read one or more lock bits associated with the selected portion. For example, the at least one logic circuit may assess lock bits similar to those depicted in FIG. 3 (e.g., using general logic circuits configured according to software or hardware accelerators configured to assess the lock bits as ON or OFF).

At step 605, the at least one logic circuit may determine whether any lock bits associated with the selected portion are activated. When there are, the at least one logic circuit may return to step 601 and select a new portion of the at least one cache. For example, the at least one logic circuit may select a new portion of the at least one cache for storing the one or more lines of data; read one or more lock bits associated with the selected new portion; and when the one or more lock bits are not activated: store the one or more lines of data in the selected new portion, and activate the one or more lock bits associated with the selected new portion.

In some embodiments, the selection of the new portion may be at least pseudo-random, as described above. In other embodiments, the selection of the new portion may be based, at least in part, on results from reading the one or more lock bits associated with the selected portion. For example, the results of step 603 may be used to adjust the portion from step 601 to construct the new portion to avoid the activated bits of the one or more lock bits.

When there are no activated bits, at step 607, the at least one logic circuit may store the one or more lines of data in the selected portion. Accordingly, any data already stored in the selected portion may be overwritten or written back to a main memory (e.g., main memory 111 of FIG. 1).

Consistent with the present disclosure, the example method 600 may include additional steps. For example, in some embodiments, method 600 may further include reading and clearing the stored one or more lines as depicted in FIG. 6B.

In some embodiments, the lock bits may be predetermined by an operating system, a program included in a BIOS, or otherwise controlled by a hardware-level software application. Additionally or alternatively, the lock bits may be dynamically activated and deactivated. For example, one or more applications may request (e.g., using an operating system, a program included in a BIOS, or any other hardware-level software application) one or more locked cache regions for instructions or data. Accordingly, once the application is terminated or otherwise no longer needs a secured region, the operating system, program included in the BIOS, or the other hardware-level software application may unlock the region(s) by deactivating the lock bit(s) of the region(s).

FIG. 6B is a flowchart of an exemplary method 650 for reading and clearing a cache region. Method 650 may be performed by at least one logic circuit (e.g., part of logic circuits 107 of processor 103 of FIG. 1). Although described using a CPU, method 650 may apply to any processor architecture using one or more caches or any software architecture using one or more caches.

In some embodiments, the at least one cache, the at least one register, and the at least one logic circuit of method 650 may comprise components of a processor. For example, the processor may comprise a central processing unit (CPU), e.g., as depicted in FIG. 1. In other embodiments, the at least one cache, the at least one register, and the at least one logic circuit of method 650 may comprise components of different processors, e.g., in a multi-processor system including a plurality of CPUs, GPUs, or the like.

At step 651, the at least one logic circuit may request one or more lines of data from at least one cache. For example, the at least one logic circuit may request instructions or other data as required by a current instruction set that the at least one logic circuit or another logic circuit is executing.

At step 653, the at least one logic circuit may read the one or more lines from the at least one cache. For example, the at least one logic circuit may transfer the lines to itself or another logic circuit for execution (if the lines are instructions) or for operation on (if the lines are data such as integers, floating decimals, strings, Booleans, or the like).

At step 655, the at least one logic circuit may determine whether the one or more lines should be cleared. For example, the at least one logic circuit may check whether the one or more lines are within a region having corresponding lock bit(s) that are activated. If so, the lines are not cleared. If not, the lines may be cleared.

In some embodiments, the at least one logic circuit may clear the one or more lines directly, e.g., by setting all bits storing the one or more lines to zeroes. In other embodiments, to increase efficiency of the at least one cache, the at least one logic circuit may mark the one or more lines as unlocked without clearing the one or more lines. Accordingly, the one or more lines will be cleared with continued use of the cache.

As explained above, the lock bit(s) may be predetermined by an operating system, a program included in a BIOS, or otherwise controlled by a hardware-level software application or may be dynamically activated and deactivated. For example, one or more applications may request (e.g., using an operating system, a program included in a BIOS, or any other hardware-level software application) one or more locked cache regions for instructions or data. Later, the operating system, program included in the BIOS, or the other hardware-level software application may unlock the region(s) by deactivating lock bit(s) of the region(s) once no longer needed. For example, if the application will require the same instructions or data again, the region(s) may be preserved. On the other hand, if the instructions or data will not be used within a threshold period of time (e.g., within a certain number of processing cycles) or the application is terminated, the region(s) may be unlocked.

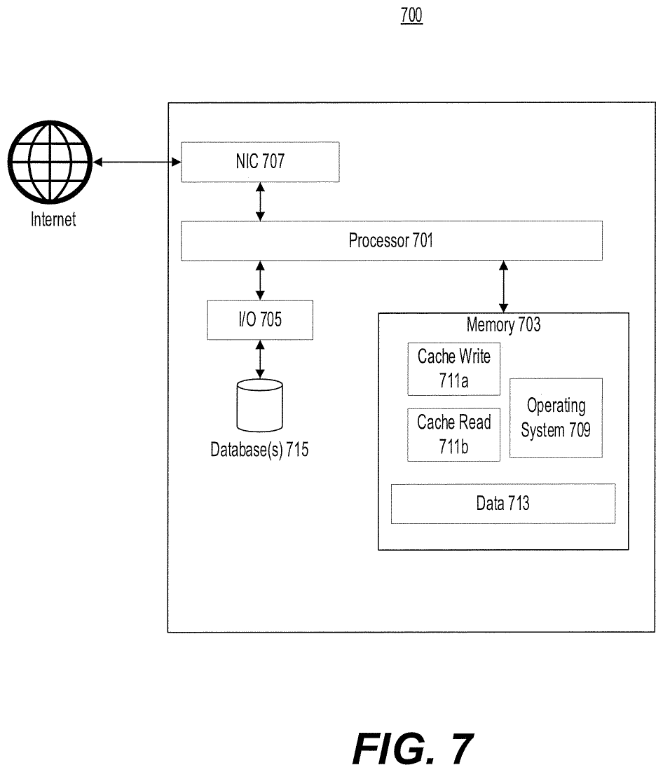

FIG. 7 is a depiction of an example system 700 for locking cache regions, consistent with embodiments of the present disclosure. Although depicted as a server FIG. 7, system 700 may comprise any computer, such as a desktop computer, a laptop computer, a tablet, or the like, configured with at least one processor to execute, for example, method 500 of FIG. 5A, method 550 of FIG. 5B, method 600 of FIG. 6A, method 650 of FIG. 6B, or any combination thereof

As depicted in FIG. 7, computer 700 may have a processor 701. Processor 701 may comprise a single processor or a plurality of processors. For example, processor 701 may comprise a CPU, a GPU, a reconfigurable array (e.g., an FPGA or other ASIC), or the like.

Processor 701 may be in operable connection with a memory 703, an input/output module 705, and a network interface controller (NIC) 707. Memory 703 may comprise a single memory or a plurality of memories. In addition, memory 703 may comprise volatile memory, non-volatile memory, or a combination thereof. As depicted in FIG. 7, memory 703 may store one or more operating systems 709, a cache write 711a, and cache read 711b. Although depicted as part of memory 703 cache write 711a and cache read 711b may comprise instructions built into or stored on processor 701.

Cache write 711a may include instructions to write locked data to a cache (e.g., as explained in method 500 of FIG. 5A or method 550 of FIG. 5B), and cache read 711b may include instructions to read or otherwise clear locked data from a cache (e.g., as explained in method 600 of FIG. 6A or method 650 of FIG. 6B).

Input/output module 705 may store and retrieve data from one or more databases 715. For example, database(s) 715 may include data to be cached by cache write 711a and cache read 711b, as described above.

NIC 707 may connect computer 700 to one or more computer networks. In the example of FIG. 7, NIC 707 connects computer 700 to the Internet. Computer 700 may receive data and instructions over a network using NIC 707 and may transmit data and instructions over a network using NIC 707. Moreover, computer 700 may receive data for caching (e.g., using cache write 711a and cache read 711b) over a network using NIC 607, as described above.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system for locking a cache region, comprising:
at least one cache configured to store data;
at least one register configured to store addresses; and
at least one logic circuit configured to perform operations comprising:
select a portion of the at least one cache for storing one or more lines of data;
apply one or more comparator functions to one or more addresses of the selected portion and the stored addresses; and
when the one or more addresses of the selected portion and the stored addresses do not overlap, store the one or more lines of data in the selected portion.

2. The system of claim 1, wherein the at least one cache, the at least one register, and the at least one logic circuit comprise components of a processor.

3. The system of claim 2, wherein the at least one cache, the at least one register, and the at least one logic circuit comprise components of a central processing unit (CPU).

4. The system of claim 1, wherein the selection is at least pseudo-random.

5. The system of claim 1, wherein the selection is based, at least in part, on the stored addresses.

6. The system of claim 1, wherein the operations further comprise, when the one or more addresses of the selected portion and the stored addresses do overlap:
select a new portion of the at least one cache for storing the one or more lines of data;
apply the one or more comparator functions to one or more addresses of the selected new portion and the stored addresses; and
when the one or more addresses of the selected new portion and the stored addresses do not overlap, store the one or more lines of data in the selected new portion.

7. The system of claim 6, wherein the selection of the new portion is at least pseudo-random.

8. The system of claim 6, wherein the selection of the new portion is based, at least in part, on results from applying the one or more comparator functions to the one or more addresses of the selected portion and the stored addresses.

9. The system of claim 1, wherein the operations further comprise:
read the stored one or more lines from the at least one cache;
determine that the one or more lines should be cleared; and
clear the one or more lines from the at least one cache.

10. The system of claim 9, wherein the one or more lines are not actively removed from the at least one cache.

11. A method for locking a cache region, comprising:
selecting a portion of at least one cache for storing one or more lines of data;
applying one or more comparator functions to one or more addresses of the selected portion and stored addresses in at least one register; and
in response to the one or more addresses of the selected portion and the stored addresses not overlapping, storing the one or more lines of data in the selected portion.

12. The method of claim 11, wherein the at least one cache, the at least one register, and the at least one logic circuit comprise components of a processor.

13. The method of claim 12, wherein the at least one cache, the at least one register, and the at least one logic circuit comprise components of a central processing unit (CPU).

14. The method of claim 11, wherein the selection is at least pseudo-random.

15. The method of claim 11, wherein the selection is based, at least in part, on the stored addresses.

16. The method of claim 11, further comprising, when the one or more addresses of the selected portion and the stored addresses do overlap:
selecting a new portion of the at least one cache for storing the one or more lines of data;
applying the one or more comparator functions to one or more addresses of the selected new portion and the stored addresses; and
when the one or more addresses of the selected new portion and the stored addresses do not overlap, storing the one or more lines of data in the selected new portion.

17. The method of claim 16, wherein the selection of the new portion is at least pseudo-random.

18. The method of claim 16, wherein the selection of the new portion is based, at least in part, on results from applying the one or more comparator functions to the one or more addresses of the selected portion and the stored addresses.

19. The method of claim 11, further comprising:
reading the stored one or more lines from the at least one cache;
determining that the one or more lines should be cleared; and
clearing the one or more lines from the at least one cache.

20. A non-transitory computer-readable storage medium storing a set of instructions that is executable by at least one logic circuit of a processor to cause the logic circuit to perform a method for locking a cache region, the method comprising:
selecting a portion of at least one cache for storing one or more lines of data;
applying one or more comparator functions to one or more addresses of the selected portion and stored addresses in at least one register; and
when the one or more addresses of the selected portion and the stored addresses do not overlap, storing the one or more lines of data in the selected portion.
